(19) United States
(12) Patent Application Publication
(10) Pub. No.: US 2025/0264855 A1
(43) Pub. Date: Aug. 21, 2025

(54) SYSTEM AND METHOD FOR ANOMALY BEHAVIOR ANALYSIS AND DETECTION IN INDUSTRIAL CONTROL SYSTEMS

(71) Applicant: NATIONAL CHENG KUNG UNIVERSITY, Tainan City (TW)

(72) Inventors: Jung-Shian LI, Tainan City (TW); I-Hsien LIU, Tainan City (TW); Pei-Wen CHOU, Tainan City (TW); Tzu-En PENG, Tainan City (TW)

(73) Assignee: NATIONAL CHENG KUNG UNIVERSITY, Tainan City (TW)

(21) Appl. No.: 18/732,332

(22) Filed: Jun. 3, 2024

(30) Foreign Application Priority Data
Feb. 21, 2024 (TW) 113106226

(51) Int. Cl. G05B 19/05

(52) U.S. Cl. CPC G05B 19/058; G05B 2219/14006

(57) ABSTRACT

The present application provides an anomaly detection system for industrial control systems, encompassing data collection, data processing, anomaly detection, and response execution modules. It uniquely employs a strategy based on Finite State Machines (FSM), actively querying the data collection module to gather operational data from sensors and Programmable Logic Controllers (PLC). The data processing module standardizes and formats the data, while the anomaly detection module uses a predefined FSM model and adaptive learning mechanisms to enhance the accuracy of anomaly identification.

### TECHNICAL FIELD

The present application relates to the technical field of industrial control network security, which can be applied to anomaly monitoring of industrial control networks to improve the security of industrial control networks, in particular to a system and a method for anomaly behavior analysis and detection in an industrial control system.

### BACKGROUND

With the development of the Industrial Control System (ICS), as automation and intelligence are continuously improved, the security and stability of the system have become the focus of research and improvement. Although the traditional anomaly detection methods can protect the system to a certain extent, these methods are unable to effectively identify and prevent anomaly behaviors in the face of more and more complex industrial environments and increasing security threats, especially in occasions that have high real-time and accuracy requirements.

In discussion about the development background of the industrial control system (ICS), it is necessary to first realize that these systems play a key role in modern industrial production. From early mechanical automation to today's intelligent manufacturing, the industrial control system (ICS) has experienced considerable development. In the middle of the 20th century, with the appearance and development of the electronic calculator, the industrial control system began to resort to automation, which marked a new stage of the industrial revolution. The system in this period mainly relies on hard-wired control and primary electronic equipment to carry out basic data processing and control tasks.

In the 21st century, with the rapid development of information technology, especially the application of the Internet of Things (IoT), big data, cloud computing, and artificial intelligence, the development of the industrial control system has entered a new era. The integration of these advanced technologies enables the industrial control system (ICS) to achieve a higher degree of automation and intelligence, thus improving production efficiency, reducing costs, and improving the reliability and safety of the system. However, it also brings new challenges, especially in the security of the system. As more and more ICSs are connected to the network, they become the targets of hacker attacks, threatening production security and data security.

For the development of the anomaly behavior analysis and detection system, it means that new strategies and technologies are needed to deal with complex and changeable security threats. Early systems may only be able to cope with simple operation errors or equipment failures, but now they must be able to identify and prevent more complex attack modes, including network attacks, malware intrusions, and internal threats. This requires that the industrial control system should not only have the ability to monitor and analyze a large amount of data in real time, but also have the ability to learn and adapt to new threats. Therefore, the development of anomaly behavior analysis and detection technology has become an important research direction to ensure the safe and stable operation of the industrial control system.

In recent years, with the development and application of artificial intelligence, machine learning, state machine, and other technologies, the anomaly behavior analysis and detection technology of the industrial control system (ICS) has also made remarkable progress. Especially, the Finite State Machine (FSM) has shown its unique advantages in system behavior modeling and anomaly detection. It can accurately describe the normal operation mode of the system through predefined states and transition rules, thus effectively identifying anomaly behaviors that deviate from the normal mode. However, even the finite state machine (FSM) method has the challenge of dealing with a highly dynamic and uncertain system environment, and further innovation and improvement are needed to improve the sensitivity and accuracy of detection.

However, in the field of abnormal operation detection of the industrial control system (ICS), the existing technology still faces a series of technical defects and challenges. Firstly, although the finite state machine (FSM) methods provide a theoretical basis for detecting abnormal operation of the ICS, these methods are often difficult to adapt to the complex and changeable industrial environment in practical applications. Especially in the face of well-designed external malicious attacks, such as the cyber attack on water treatment facilities in Florida in 2021, it is difficult for existing technologies to identify and respond to these threats in time and accurately. This kind of attack not only involves the nonstandard behavior of system operation but also may pose a direct threat to public safety. Therefore, improving the efficiency and accuracy of anomaly detection has become an urgent problem to be solved.

Secondly, the current anomaly detection systems often rely on static rules or models, which limits their adaptability in the face of dynamic changes in system behavior. For example, when the industrial control system is upgraded or the configuration changes, the old detection model may no longer be effective, and manual intervention is needed to update the rules, which is not only time-consuming and labor-intensive but also may not guarantee the continuous security of the system in the face of continuous attacks. Furthermore, although the finite state machine (FSM) provides an effective way to simulate and monitor the system state transition, in practice, how to design a finite state machine (FSM) that can not only cover all normal operating states but also sensitively detect abnormal state transitions is a technical challenge. In addition, for large-scale industrial control systems (ICS), the number of states may be very large, which makes the maintenance and updating of the finite state machines (FSM) complicated and difficult.

Traditionally, the main disadvantages of passive monitoring industrial control network security systems include long response time, the possibility of missing minor anomalies or unauthorized operations, and weak ability to update and adapt to new threat patterns. This is because passive systems rely on monitoring network activities to detect anomaly behaviors, and may not detect anomalies without obvious network activities, and mainly rely on known attack characteristics or anomaly behavior patterns for monitoring, therefore new or changed attack strategies may not be timely identified.

Finally, even if the anomaly detection system is successfully deployed, how to ensure that maintenance personnel can be notified in time when potential threats are detected and effective countermeasures can be taken is also a problem worthy of attention. In many cases, due to the lack of an effective alarm mechanism or the lack of timely response of maintenance personnel to the alarm, security incidents have occurred.

To sum up, although the finite state machine method provides a possible solution for abnormal operation detection of the industrial control system (ICS) in theory, in practice, how to design a detection system that can effectively adapt to a complex industrial environment, identify external malicious attacks in time and accurately, and flexibly adapt to system changes is still a technical problem to be solved urgently. In addition, how to improve the user responsiveness of the system and ensure that measures can be taken quickly when abnormalities are detected is also the key to improving the security of the ICS.

Given the shortcomings of the prior art, the present application provides an anomaly behavior analysis and detection system and method in an industrial control system. Compared with the prior art, the anomaly behavior analysis and detection system and method for an industrial control system of the present application effectively overcome the shortcomings of the traditional method in dealing with complex and changeable industrial environments and external malicious attacks by actively inquiring. By combining finite state machine (FSM) with advanced data analysis technology, this solution can dynamically adapt to the changes in system behavior, and timely and accurately identify non-standard operation behaviors, thus greatly improving the efficiency and accuracy of anomaly detection. In addition, the design of this system takes into account the needs for low-cost implementation and high-efficiency maintenance at the same time, ensuring the safe and stable operation of the industrial control system and achieving economical and efficient operation and maintenance management.

### SUMMARY

The present application provides an anomaly behavior analysis and detection system in an industrial control system, which mainly includes a data collection module, a data processing module, an anomaly detection module, and a response execution module, wherein the system particularly adopts a strategy based on a finite state machine (FSM), and collects operation data from a sensor and a Programmable Logic Controller (PLC) by actively querying the data collection module; the data is standardized and format converted by the data processing module. The anomaly detection module combines the adaptive learning unit according to the predefined finite state machine (FSM) model to improve the accuracy of anomaly identification.

Therefore, in order to achieve the object of the present application, the present application provides an anomaly behavior analysis and detection system in an industrial control system, which includes: a data collection module configured for collecting operation data from the industrial control system; a data processing module configured for preliminarily processing the collected operation data; an anomaly detection module, including one or more detection units based on a finite state machine (FSM) configured for actively querying and analyzing the processed data according to a predefined state machine model to identify potential anomaly behaviors; and a response execution module configured for executing predefined response measures after the anomaly behaviors are identified by the detection unit; wherein, the anomaly detection module is enabled, through an actively-querying finite state machine (FSM) mechanism, to identify non-standard operation behaviors more effectively, and perform a high-frequency and high-accuracy anomaly behavior detection function in the industrial control system.

Wherein, the anomaly behavior analysis and detection system in the industrial control system enhances information exchange and security between devices through a Modbus/TCP communication protocol, and constructs a Programmable Logic Controller (PLC) state set through continuous discovery and monitoring on PLC states.

Wherein, the data collection module further includes a sensor data interface unit for directly collecting operation data from the sensors in the industrial control system, so as to improve the real-time and accuracy of data collection.

Wherein, the data processing module includes a data standardization unit for converting the collected operation data into a unified format for subsequent anomaly detection and analysis.

Wherein, the detection unit of the anomaly detection module is further provided with an adaptive learning unit so as to automatically adjust detection parameters based on historical data to improve the accuracy of identification of anomaly behaviors.

Wherein, the response execution module further includes a security incident log recording unit for recording all the identified anomaly behaviors and the response measures of the system, so as to facilitate post-incident analysis and audit.

Wherein, by setting different monitoring frequencies in the anomaly detection module, a frequency of the active query is allowed to be dynamically adjusted according to an actual operation of the industrial control system, thereby effectively improving the detection sensitivity of the anomaly behaviors without adding additional system burden.

In addition, the present application further provides an anomaly behavior analysis and detection method in an industrial control system, including the following steps: (S01) collecting, by a data collection module, operation data from sensors and programmable logic controllers (PLCs) of the industrial control system; (S02) preliminarily processing, by a data processing module, the collected operation data, including data standardization and format conversion; (S03) carrying out information exchange between devices by a Modbus/TCP communication protocol to enhance the safety and accuracy of data collection; (S04) constructing a programmable logic controller (PLC) state set for continuously monitoring the operation state of the PLC; (S05) actively querying and analyzing, according to a predefined state machine model, the processed data through a detection unit in an anomaly detection module; (S06) the detection unit automatically adjusting detection parameters according to historical data by using an adaptive learning unit to improve the identification accuracy of anomaly behaviors; (S07) executing predefined response measures by a response execution module when anomaly behaviors are recognized by the detection unit, including giving an alarm and automatically adjusting the operation parameters of the system; and (S08) recording all identified anomaly behaviors and system response measures in a security incident log for post-incident analysis and audit.

Wherein, the steps (S04) and (S07) respectively include the following detailed steps: (S041) further continuously monitors output values of various sensors in the industrial control system by a sensor data interface unit, so as to update the programmable logic controller (PLC) state set in real time and ensure the real-time identification of the abnormal state of the system; and (S071) implementing differentiated response strategies according to the types of anomalies, such as immediately disconnecting the power supply of related devices for high-security anomalies, and adjusting operation parameters for performance-affecting anomalies to optimize the performance of the system.

Wherein, the step (S05) includes the following detailed steps: (S051) further analyzing the processed data by an anomaly detection module using enhanced data analysis techniques, including machine learning algorithm and pattern recognition, thus improving the recognition ability and accuracy of detection for complex anomaly behaviors.

The object, technical content, characteristics, and effects of the present application will be more easily understood by the following detailed description of specific embodiments.

### BRIEF DESCRIPTION OF DRAWINGS

FIG. 1 is an architecture diagram of an anomaly behavior analysis and detection system in an industrial control system according to the present application;

FIG. 2 is a schematic diagram of the operation of the present application;

FIG. 3 is an industrial control flow chart of the present application applied to an industrial control network system;

FIG. 4 is an inspection result diagram of the present application applied to the industrial control process of FIG. 3;

FIG. 5 is a schematic diagram of the application of the present application applied to the industrial control process of FIG. 3;

FIG. 6 is the first flowchart of an anomaly behavior analysis and detection method in an industrial control system according to the present application; and

FIG. 7 is a second flowchart of an anomaly behavior analysis and detection method in an industrial control system according to the present application.

### DESCRIPTION OF EMBODIMENTS

The inventive concept will now be explained more fully hereinafter with reference to the accompanying drawings in which exemplary embodiments of the inventive concept are shown. The advantages and features of the concept of the present application, as well as the method of achieving the same, will be apparent from the following exemplary embodiments described in more detail with reference to the attached drawings.

The terminology used herein is only used to describe specific embodiments and is not intended to limit the present application. Unless the context clearly indicates otherwise, the singular forms of the terms “a” and “the” used herein are intended to include the plural forms. The term “and/or” as used here includes any and all combinations of one or more of the related listed items. It should be understood that when an element is said to be “connected” or “coupled” to another element, the element may be directly connected or coupled to the other element or intervening elements may be present.

Exemplary embodiments are described herein with reference to the drawings, wherein the drawings are idealized exemplary explanatory diagrams. Therefore, deviations from the illustrated shape caused by, for example, manufacturing techniques and/or tolerances are expected. Therefore, the regions shown in the figures are schematic, and their shapes are not intended to illustrate the actual shape of the device, nor are they intended to limit the scope of the exemplary embodiments.

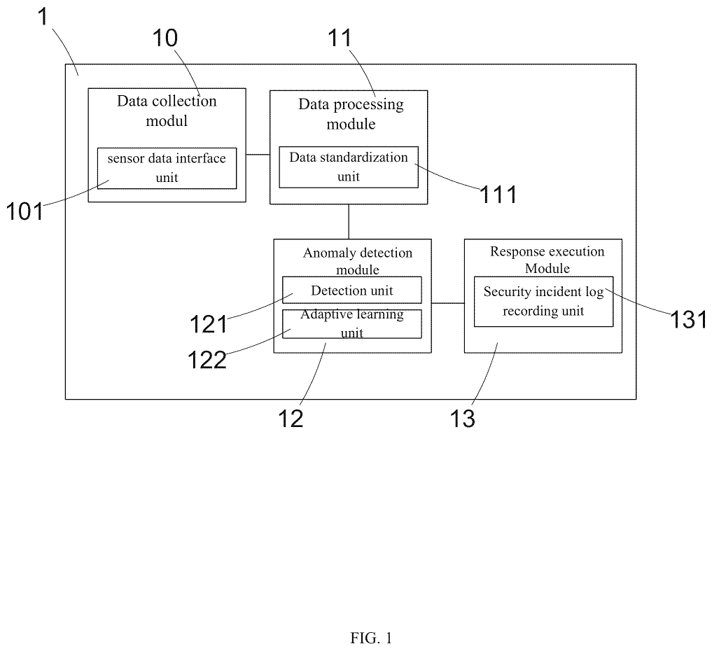

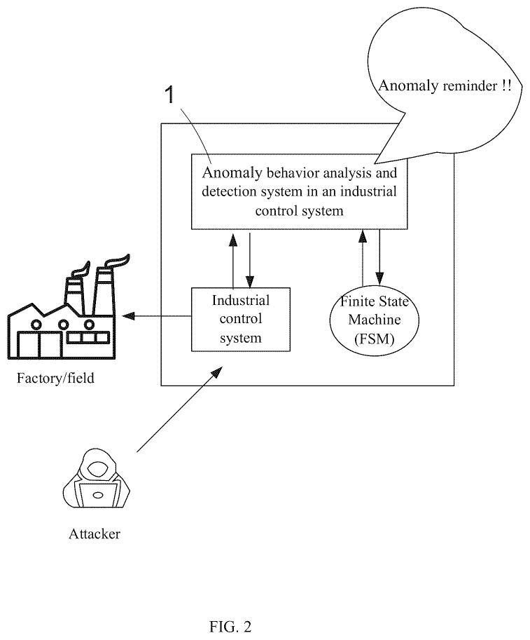

Referring to FIG. 1 and FIG. 2 together, FIG. 1 is an architecture diagram of an anomaly behavior analysis and detection system in an industrial control system of the present application, and FIG. 2 is a schematic operation diagram of the present application. As shown in the figures, an anomaly behavior analysis and detection system in an industrial control system according to the present application is implemented by being combined with an Industrial Control System (ICS), wherein the anomaly behavior analysis and detection system 1 of the industrial control system mainly includes a data collection module 10, a data processing module 11, an anomaly detection module 12 and a response execution module 13.

Wherein, the data collection module 10 is configured for collecting operation data from the industrial control system; the data processing module 11 is configured for preliminarily processing the collected operation data; the anomaly detection module 12 includes one or more detection units 121 based on a finite state machine (FSM), and the detection unit 121 is configured for actively querying and analyzing the processed data according to a predefined state machine model to identify potential anomaly behaviors.

Furthermore, the response execution module 13 is configured for executing predefined response measures after the anomaly behaviors are identified by the detection unit 121; wherein, the anomaly detection module 12 is enabled, through an actively-querying finite state machine (FSM) mechanism, to identify non-standard operation behaviors more effectively, and perform a high-frequency and high-accuracy anomaly behavior detection function in the industrial control system.

The anomaly behavior analysis and detection method adopted in this case takes the finite state machine (FSM) as the core and realizes an innovative and efficient anomaly detection strategy. The finite state machine (FSM) is a mathematical model used to represent a limited number of states and their transitions, which is widely used in software and hardware design. In this case, the finite state machine (FSM) is designed to describe various possible states and their transition conditions during the normal operation of the industrial control system, thus providing a clear and reliable reference for the identification of anomaly behaviors.

The operation mode of this solution is as follows: firstly, the system collects operation data from the industrial control system through the data collection module. These data include but are not limited to, readings from sensors, state information of the programmable logic controller (PLC), etc. Subsequently, the data processing module preprocesses the collected data, including standardization and denoising, so as to facilitate subsequent analysis and processing. Then, the detection unit based on the finite state machine (FSM) in the anomaly detection module will actively query and analyze the processed data according to the predefined state machine model. During this process, the detection unit will evaluate whether the current state of the system meets any abnormal state transition conditions defined in the finite state machine (FSM) model. Once the behavior or data pattern corresponding to the abnormal state is identified, the system will immediately trigger the response execution module to take corresponding predefined response measures, such as issuing an alarm, automatically adjusting control parameters, or disconnecting the power supply of key equipment.

More specifically, in this embodiment, the system is used to enhance information exchange and security between devices through a Modbus/TCP communication protocol and to build a PLC state set through continuous discovery and monitoring of the state of the PLC.

Wherein, in this technical solution, firstly, a stable and reliable data exchange mode is realized through the Modbus/TCP communication protocol, which supports cross-vendor equipment connection and communication, and ensures the security and efficiency of information exchange. The specific implementation includes configuring the network interface to ensure the implementation of data encryption and authentication mechanisms, so as to prevent unauthorized access and data tampering.

Secondly, the continuous discovery and monitoring of the state of the PLC further improves the ability of the system to identify anomaly behaviors. By deploying high-precision sensors and advanced monitoring algorithms, the system can track the operation state of the PLC in real time, and compare this information with the predefined normal operation mode. Once any deviation is found, an anomaly processing can be started immediately. This method can not only quickly respond to potential operation problems but also prevent possible anomalies in the future through data analysis, thus greatly improving the stability and security of the entire industrial control system.

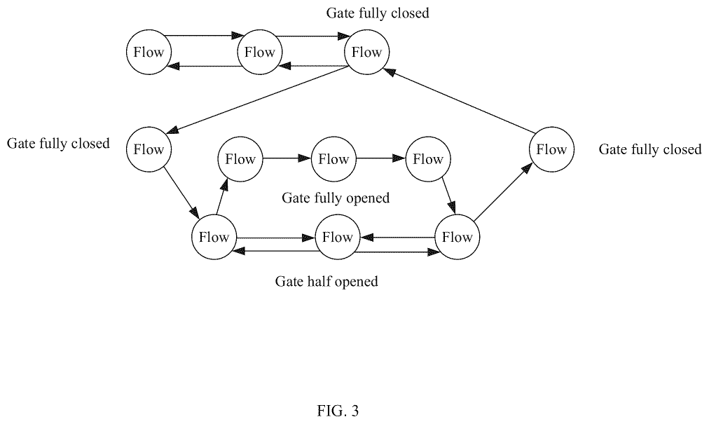

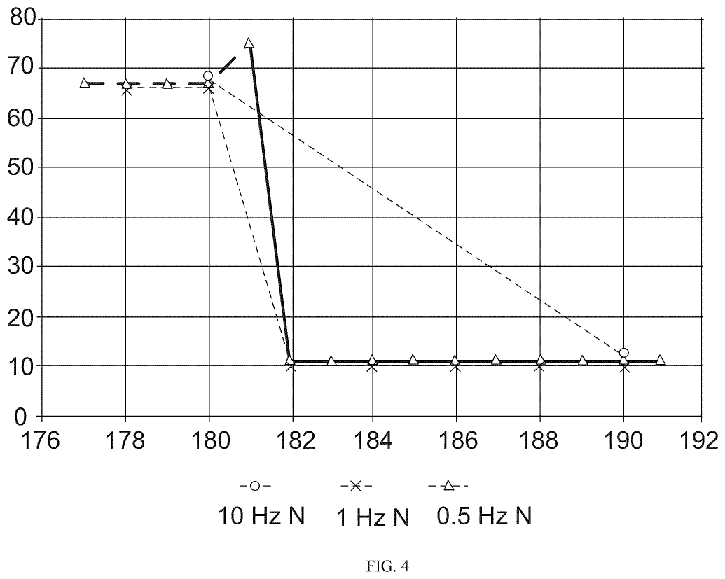

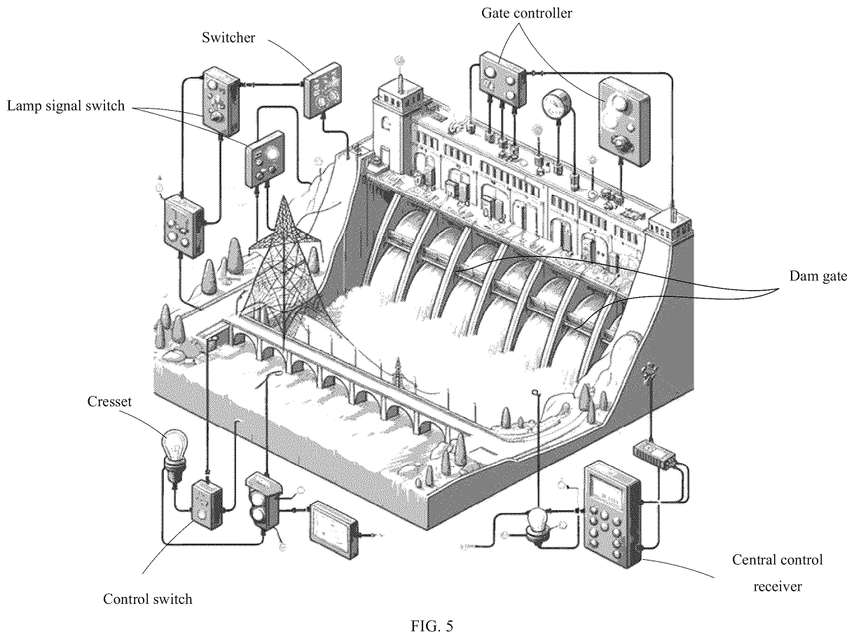

Please refer to FIGS. 1 to 5 at the same time, in which, FIG. 3 is an industrial control flow chart of the present application applied to an industrial control network system, FIG. 4 is an inspection result chart of the present application applied to the industrial control flow chart of FIG. 3, and FIG. 5 is a schematic diagram of the present application applied to the industrial control flow chart of FIG. 3. In the verification background of this embodiment, the technology of this application is applied to the anomaly behavior detection of a dam control system, and d a virtual dam gate anomaly detection test platform is established. This platform uses a Modbus communication protocol to scan the state of the programmable logic controller (PLC), and the scanning interval is set to 0.1 seconds, with a rest of 1 second after each scan to simulate the actual operating conditions. Through infinite scanning, the results of each observation are recorded, which provides a basis for the subsequent discussion of potential changes and system behaviors. The goal of this test platform is to fully understand the anomaly detection performance of the virtual dam gate system.

In terms of experimental results, the system effectively conveys various states and operation stages of the gate through different light changes. When the gate is in remote monitoring mode, a remote lamp lights up, indicating that the system is operating normally. However, if it is necessary to discharge water from the gate, the personnel must abide by the regulations and be present in person. At this time, the system will switch to a field mode and activate the power lamp. With the start of the operation, if it is necessary to open the gate, the rising lamp will be activated, marking the rising action of the gate. When the gate is fully opened to a specified height, the rising lamp goes out, and a field lamp and a power lamp are on at the same time, indicating that the gate has been fully opened. When the gate is fully opened at the bottom, a fully-open lamp lamps up, the rising lamp goes out and the descending lamp is activated, indicating that the gate is about to descend.

However, in the process of operation, abnormal situations may occur, such as a short circuit or system failure, which may cause the gate to loosen or get stuck in the process of rising, thus resulting in an overload state. In these cases, the system should respond quickly, such as activating the corresponding warning lamps to prompt the operators to carry out maintenance or emergency treatment measures. To sum up, the system can skillfully convey different states and stages of gate operation through unique lighting tips. In addition, it can quickly give a warning when an abnormal situation occurs, ensuring the safety and manageability of the operation.

In the analysis and detection of anomaly behavior of dam control systems, it is particularly important to adopt the finite state machine (FSM) technology in the face of complex causality and potential security threats. The finite state machine (FSM) technology allows the system to record and monitor the logic of the whole industrial control network through high-frequency access, and effectively track every operation step and state change, thus ensuring that the preset scene conditions can be accurately executed in the whole operation process. This not only improves the reliability and safety of the system but also greatly reduces the potential risk caused by the attack on the dam control system.

The system can monitor the correctness of each gate operation in real time to ensure that all operations are carried out under safe conditions, and when the system detects any anomaly behavior that does not conform to the predefined state model, it can immediately start the early warning mechanism and take appropriate emergency measures to avoid potential disasters. This real-time response ability is very important to protect the lives and property of residents downstream of the dam.

Moreover, when the technology of the present application is applied to this implementation scenario, it is more helpful to improve the protection ability of the dam control system against external attacks. By closely monitoring the operation logic of the system and identifying anomaly behaviors in time, malicious attacks can be effectively identified and blocked, and hackers can be prevented from controlling the dam gate through network intrusion, thus ensuring the safety of national water resources and ecosystems. In this way, in practical operations, the application and introduction of the technology of the present application not only improves the automation and intelligence level of the dam control system, but also enhances the stability and fault diagnosis ability of the system, and can minimize the loss caused by operational errors or system failures through accurate identification and rapid processing of abnormal states. It can not only ensure that every step in the operation process conforms to the safety specifications but also respond quickly in the face of abnormal situations, effectively preventing and alleviating the possible serious consequences caused by the failure or attack of the dam control system. This technical solution provides an efficient and reliable solution for dam safety management.

In addition, in more detail, in the technology of this case, the data collection module 10 further includes a sensor data interface unit 101, which is used to collect operation data directly from the sensors of the industrial control system, so as to improve the real-time and accuracy of data collection. Moreover, the data processing module 11 includes a data standardization unit 111, which is used to convert the collected operation data into a unified format, so as to facilitate the subsequent anomaly detection and analysis.

Wherein, the detection unit 121 of the anomaly detection module is further provided with an adaptive learning unit 122 so that it can automatically adjust the detection parameters based on historical data to improve the accuracy of anomaly behavior identification. Furthermore, the response execution module 13 further includes a security incident log recording unit 131, which is used to record all the identified anomaly behaviors and the response measures of the system, so as to facilitate post-incident analysis and audit. In addition, by setting different monitoring frequencies in the anomaly detection module, the frequency of active query can be dynamically adjusted according to the actual operation of the industrial control system, so that the detection sensitivity of anomaly behavior can be effectively improved without adding additional system burden.

It is worth mentioning that in the implementation of this technology, the advanced data collection and processing mechanism is helpful to significantly improve the real-time ability and accuracy of anomaly detection industrial control systems. With the introduction of the data interface unit of the sensor, the operation data is directly collected from sensors. This direct data acquisition method reduces the delay and distortion in the data transmission process and ensures the originality and reliability of the data. Further, the collected data is converted into a unified format by the data standardization unit, which lays a solid foundation for the subsequent anomaly detection and analysis and will ensure the consistency and efficiency of data analysis.

Wherein, the adaptive learning unit of the anomaly detection module further enhances the accuracy of the system's identification of anomaly behaviors, and by learning historical data, the system can automatically adjust the detection parameters, which enables the system to maintain efficient identification performance in the face of changing operating conditions and new types of anomaly behaviors. In addition, through the setting of the security incident log recording unit, it not only provides a reliable basis for recording anomaly behaviors but also provides rich data resources for post-incident analysis and audit. At the same time, by dynamically adjusting the monitoring frequency of the anomaly detection module, it will facilitate the technology in this case to effectively improve the sensitivity and adaptability of anomaly detection without increasing the system burden, which is incomparable to traditional systems.

It is worth emphasizing that the technical feature of this case adopts industrial control network monitoring of an active access form, in which, by adjusting the monitoring frequency, the system can capture the changes in the operation process of the industrial control system more finely, thus improving the learning and supervision ability of the whole industrial control logic. This method allows the system to dynamically adjust the scanning frequency according to the current operating conditions and the identified abnormal patterns, which not only ensures the efficient use of resources but also ensures the sensitivity and accuracy of anomaly detection. For example, when the system is operated stably, the scanning frequency can be reduced to save computing resources, or the scanning with an unspecified frequency can be performed. At this time, the scanning frequency can be increased when the system detects potential anomalies or enters a critical operation stage, so as to capture possible anomaly behaviors in real time. By such a mechanism, the adaptive adjustment mechanism ensures that the system can maintain the best monitoring efficiency under various operating conditions, thereby improving the safety and reliability of the industrial control system.

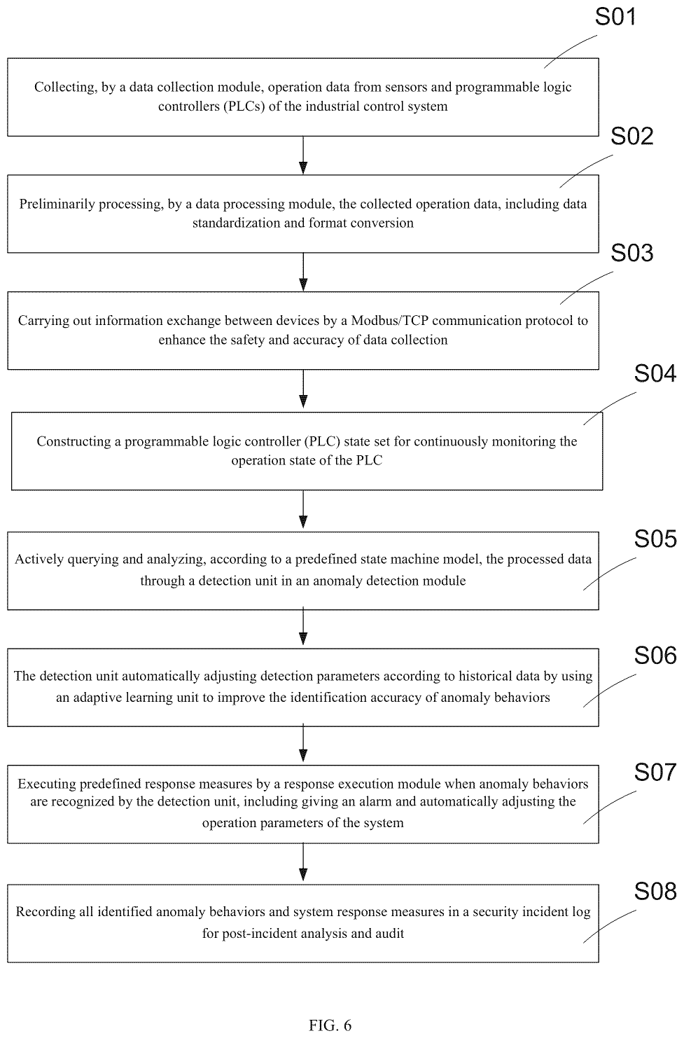

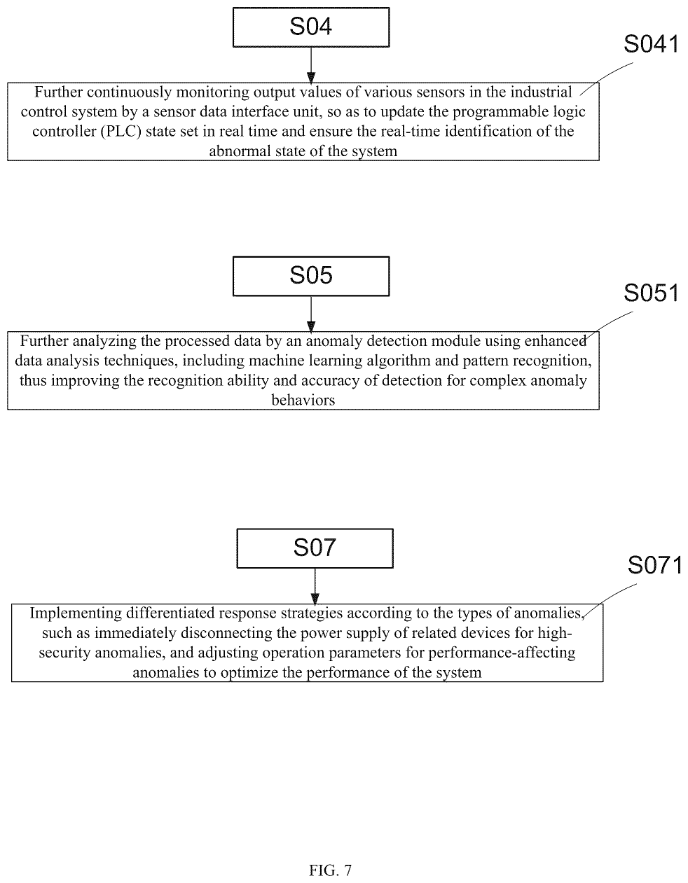

On the other hand, please refer to FIG. 6 and FIG. 7, which are the first flowchart and the second flowchart of an anomaly behavior analysis and detection method in an industrial control system according to the present application. As shown in the figures, the present application further proposes an anomaly behavior analysis and detection method in an industrial control system, which includes the following steps: firstly, the system executes step (S01) to collect operation data from sensors and programmable logic controllers (PLCs) of the industrial control system through a data collection module; next, the system executes steps (S02) and (S03), and uses the data processing module to preliminarily process the collected operation data, including data standardization and format conversion; the Modbus/TCP communication protocol is used to exchange information between devices to enhance the security and accuracy of data collection.

After the above steps are completed, the system sequentially executes the steps (S04) to build a PLC state set for continuously monitoring the operation state of the PLC; and in step (S05), according to the predefined state machine model, the processed data is actively queried and analyzed through the detection unit in the anomaly detection module; in step (S06), the detection unit uses an adaptive learning unit to automatically adjust the detection parameters according to the historical data to improve the accuracy of anomaly behavior identification; finally, this solution runs steps (S07) and (S08), in which when the anomaly behavior is identified by the detection unit, the response execution module executes predefined response measures, including giving an alarm and automatically adjusting the system operation parameters; at the same time, all identified anomaly behaviors and system response measures are recorded in the security incident log for post-incident analysis and audit.

In view of the above, the present application proposes an anomaly behavior analysis and detection method for the industrial control system, which focuses on collecting operation data from sensors and programmable logic controllers (PLCs) through a data collection module and standardizing and converting the data by using a data processing module, wherein the Modbus/TCP communication protocol enhances the security and accuracy of data exchange. In addition, the system constructs a programmable logic controller (PLC) state set to continuously monitor the operation state and carries out anomaly detection according to the predefined state machine model. The detection unit adopts an adaptive learning unit to improve the identification accuracy. When the anomaly behavior is identified, the system executes predefined response measures and records them in the security incident log for subsequent analysis and audit.

Furthermore, in this method technology, the steps (S04) and (S07) respectively include the following detailed steps: in step (S041), the output values of various sensors in the industrial control system are continuously monitored by using the sensor data interface unit to update the programmable logic controller (PLC) state set in real time to ensure the real-time identification of the abnormal state of the system; and in step (S071), differentiated response strategies are implemented according to the types of anomalies, such as immediately disconnecting the power supply of related devices for anomalies with high safety, and operation parameters are adjusted for anomalies with performance impact to optimize system performance.

In addition, in this method technology, this step (S05) includes the following detailed steps: in step (S051), the anomaly detection module further uses enhanced data analysis technology, including machine learning algorithm and pattern recognition, to analyze the processed data, thereby improving the recognition ability and detection accuracy of complex anomaly behaviors.

In this way, the technical characteristics and advantages of this case are mainly reflected in the following aspects:

(1) high automation and real-time: through active query and analysis based on the finite state machine (FSM), the system can identify anomaly behaviors in real time, greatly shortening the time of anomaly detection and response, and improving the ability of the system to deal with sudden abnormal situations.

(2) high accuracy: the predefined finite state machine (FSM) model allows the system to accurately describe and identify the normal and abnormal states of the industrial control system, thus reducing the risk of false positives and false negatives.

(3) adaptability and flexibility: the detection unit based on the finite state machine (FSM) can adaptively adjust the detection strategies and parameters according to the actual operation experience, which improves the adaptability of the system to the emerging abnormal patterns.

(4) maintenance and maintainability: the standardized and modular design of the finite state machine (FSM) model makes the system easy to maintain and upgrade, and can flexibly respond to the changes of industrial control systems and emerging security threats.

To sum up, this embodiment not only improves the efficiency and accuracy of anomaly detection, but also enhances the real-time response ability of the system to anomaly behavior by combining the active query and analysis of finite state machine, and provides an efficient, reliable and easy-to-maintain security protection solution for the industrial control system.

The present application has been described above with reference to the embodiments, but the above description is only for making the people familiar with the technology and easily understand the contents of the present application and is not used to limit the scope of the rights of the present application. Various equivalent changes can be contemplated by those skilled in the art within the same spirit of the present application. For example, the signal connections between components and units that are not specified in detail can be wired or wireless. The scope of the present application shall cover different embodiments or all other combinations of equivalent variations.

What is claimed is:

1. An anomaly behavior analysis and detection system in an industrial control system, comprising:
a data collection module configured for collecting operation data from the industrial control system;
a data processing module configured for preliminarily processing the collected operation data;
an anomaly detection module, including one or more detection units based on a finite state machine (FSM) configured for actively querying and analyzing the processed data according to a predefined state machine model to identify potential anomaly behaviors; and
a response execution module configured for executing predefined response measures after the anomaly behaviors are identified by the detection unit;
wherein, the anomaly detection module is enabled, through an actively-querying finite state machine (FSM) mechanism, to identify non-standard operation behaviors more effectively, and perform a high-frequency and high-accuracy anomaly behavior detection function in the industrial control system.

2. The anomaly behavior analysis and detection system in an industrial control system according to claim 1, wherein the anomaly behavior analysis and detection system in the industrial control system enhances information exchange and security between devices through a Modbus/TCP communication protocol and constructs a Programmable Logic Controller (PLC) state set through continuous discovery and monitoring on PLC states.

3. The anomaly behavior analysis and detection system in an industrial control system according to claim 1, wherein the data collection module further comprises a sensor data interface unit for directly collecting operation data from the sensors in the industrial control system, so as to improve the real-time and accuracy of data collection.

4. The anomaly behavior analysis and detection system in an industrial control system according to claim 1, wherein the data processing module comprises a data standardization unit for converting the collected operation data into a unified format for subsequent anomaly detection and analysis.

5. The anomaly behavior analysis and detection system in an industrial control system according to claim 1, wherein the detection unit of the anomaly detection module is further provided with an adaptive learning unit so as to automatically adjust detection parameters based on historical data to improve the accuracy of identification of anomaly behaviors.

6. The anomaly behavior analysis and detection system in an industrial control system according to claim 2, wherein the response execution module further comprises a security incident log recording unit for recording all the identified anomaly behaviors and the response measures of the system, so as to facilitate post-incident analysis and audit.

7. The anomaly behavior analysis and detection system in an industrial control system according to claim 1, wherein by setting different monitoring frequencies in the anomaly detection module, a frequency of the active query is allowed to be dynamically adjusted according to an actual operation of the industrial control system, thereby effectively improving the detection sensitivity of the anomaly behaviors without adding additional system burden.

8. An anomaly behavior analysis and detection method in an industrial control system, comprising the following steps:
(S01) collecting, by a data collection module, operation data from sensors and programmable logic controllers (PLCs) of the industrial control system;
(S02) preliminarily processing, by a data processing module, the collected operation data, including data standardization and format conversion;
(S03) carrying out information exchange between devices by a Modbus/TCP communication protocol to enhance the safety and accuracy of data collection;
(S04) constructing a programmable logic controller (PLC) state set for continuously monitoring the operation state of the PLC;
(S05) actively querying and analyzing, according to a predefined state machine model, the processed data through a detection unit in an anomaly detection module;
(S06) the detection unit automatically adjusting detection parameters according to historical data by using an adaptive learning unit to improve the identification accuracy of anomaly behaviors;
(S07) executing predefined response measures by a response execution module when anomaly behaviors are recognized by the detection unit, including giving an alarm and automatically adjusting the operation parameters of the system; and
(S08) recording all identified anomaly behaviors and system response measures in a security incident log for post-incident analysis and audit.

9. The anomaly behavior analysis and detection method in an industrial control system according to claim 8, wherein the steps (S04) and (S07) respectively comprise the following detailed steps:
(S041) further continuously monitors output values of various sensors in the industrial control system by a sensor data interface unit, so as to update the programmable logic controller (PLC) state set in real time and ensure the real-time identification of the abnormal state of the system; and
(S071) implementing differentiated response strategies according to the types of anomalies, such as immediately disconnecting the power supply of related devices for high-security anomalies, and adjusting operation parameters for performance-affecting anomalies to optimize the performance of the system.

10. The anomaly behavior analysis and detection method in an industrial control system according to claim 8, wherein the step (S05) comprises the following detailed steps:
(S051) further analyzing the processed data by an anomaly detection module using enhanced data analysis techniques, including machine learning algorithm and pattern recognition, thus improving the recognition ability and accuracy of detection for complex anomaly behaviors.
